(19) United States
(12) Patent Application Publication
(10) Pub. No.: US 2025/0158142 A1
(43) Pub. Date: May 15, 2025

(54) METHOD FOR MANUFACTURING BIPOLAR BATTERY

(71) Applicant: TOYOTA JIDOSHA KABUSHIKI KAISHA, Toyota-shi (JP)

(72) Inventors: Mitsuru TATEISHI, Toyota-shi (JP); Hajime HASEGAWA, Aichi-gun (JP); Shinya TAKESHITA, Toyota-shi (JP); Chihiro MATSUDA, Toyohashi-shi (JP); Tomoyuki KAWAI, Kariya-shi (JP); Kisena YOSHIDA, Kariya-shi (JP)

(73) Assignee: TOYOTA JIDOSHA KABUSHIKI KAISHA, Toyota-shi (JP)

(21) Appl. No.: 18/921,517

(22) Filed: Oct. 21, 2024

(30) Foreign Application Priority Data
Nov. 13, 2023 (JP) 2023-193249

(51) Int. Cl. H01M 10/44; H01M 4/58; H01M 10/0585

(52) U.S. Cl. CPC H01M 10/441; H01M 4/5825; H01M 10/0585

(57) ABSTRACT

A method for manufacturing a bipolar secondary battery includes an initial charging step of charging, to a specified voltage, a first cell group including multiple cells arranged at every other tier in a stacking direction, and a second cell group including multiple cells arranged next to the respective cells included in the first cell group, a high-temperature aging step of performing aging at a higher temperature than room temperature, and an under-aging charging step of alternately charging the first and second cell groups until the first and second cell groups reach the specified voltage. In the under-aging charging step, a charging completion condition for at least one of the first and second cell groups is determined based on a dissolution rate calculated based on a metal foreign substance type and a positive electrode potential, and a voltage and an aging time of each cell in the under-aging charging step.

### CROSS-REFERENCE TO RELATED APPLICATION

This application claims priority to Japanese Patent Application No. 2023-193249 filed on Nov. 13, 2023, incorporated herein by reference in its entirety.

### BACKGROUND

### 1. Technical Field

The disclosure relates to a method for manufacturing a bipolar battery.

### 2. Description of Related Art

A technique including a high-temperature aging step of uniformizing the quality of cells by holding assembled cells at a high temperature for a long period of time to facilitate impregnation of an electrolytic solution into electrode layers and the progress of irreversible side reactions other than a cell reaction has been hitherto known in a method for manufacturing a secondary battery such as a lithium ion secondary battery. Japanese Unexamined Patent Application Publication No. 2015-122160 discloses a technique that enables quality assurance while ensuring battery capacities by adjusting a subsequent aging condition when the temperature or time deviates from a standard range during high-temperature aging.

### SUMMARY

In a bipolar battery having a bipolar structure, each cell is charged by using terminals shared with adjacent cells thereto in a stacking direction, so that it is necessary to separately charge cells stacked in even numbers and cells stacked in odd numbers in the stacking direction. Therefore, the time required for a high-temperature aging step in which charging is performed to smoothly dissolve foreign substances may be longer.

The present disclosure has been made in consideration of the above fact, and has an object to provide a method for manufacturing a bipolar secondary battery that is capable of shortening a high-temperature aging time in a high-temperature aging step.

According to the present disclosure recited in claim 1, a method for manufacturing a bipolar secondary battery in which a plurality of cells each including a positive electrode, a negative electrode, and an electrolyte layer are stacked, includes an initial charging step of charging, to a specified voltage, a first cell group including a plurality of cells arranged at every other tier in a stacking direction, and a second cell group including a plurality of cells arranged next to the respective cells included in the first cell group, a high-temperature aging step of performing aging at a high temperature higher than room temperature, and an under-aging charging step of alternately charging the first cell group and the second cell group in the high-temperature aging step until the first cell group and the second cell group reach the specified voltage, wherein in the under-aging charging step, a charging completion condition for at least one of the first cell group and the second cell group is determined based on a dissolution rate calculated based on a type of a metal foreign substance and a positive electrode potential, and a voltage and an aging time of each of the cells in the under-aging charging step.

The method for manufacturing a bipolar secondary battery according to the present disclosure recited in claim 1 includes, in the high-temperature aging step, the under-aging charging step of alternately charging the first cell group including a plurality of cells arranged at every other tier in a stacking direction, and the second cell group including a plurality of cells arranged next to the respective cells included in the first cell group until the first cell group and the second cell group have reached a specified voltage. In the under-aging charging step, the charging completion condition for at least one of the first cell group and the second cell group is determined based on the dissolution rate calculated based on the type of metal foreign substance and the positive electrode potential, and the voltage and aging time of each of the cells in the under-aging charging step. As described above, since the charging completion condition is determined based on the dissolution rate calculated based on the type of metal foreign substance and the positive electrode potential, and the voltage and aging time of each of the cells in the under-aging charging step, it is possible to shorten the time required for completing charging in the high-temperature aging step as compared with a case in which charging is completed under a completion condition set for a lowest-voltage cell without considering the dissolution rate of foreign substance as in a related art, so that the high-temperature aging time can be shortened.

Furthermore, according to a method for manufacturing a bipolar secondary battery according to the present disclosure recited in claim 2, in the configuration recited in claim 1, in the under-aging charging step, a switching charging capacity or a switching charging time may be set as a switching determination condition for switching charging of the cells serving as charging targets, the switching charging capacity has a value smaller than a charging capacity in previous charging, and the switching charging time is a time shorter than a charging time in the previous charging.

As an example, while the first charging of the second cell group is being performed after the first charging of the first cell group is completed, each cell of the first cell group may be discharged. Therefore, in the second and subsequent charging of the first cell group, charges that have been lost in a charging standby state are replenished, so that the charging capacity gradually decreases as compared with the first charging. In other words, the cells are closer to full charge as the number of charging times increases, so that the charging capacity decreases.

Therefore, in the method for manufacturing a bipolar secondary battery according to the present disclosure recited in claim 2, the switching charging capacity is set to a value smaller than the charging capacity in the previous charging as the charging switching determination condition for the cells serving as charging targets, and the switching charging time is set to a time shorter than the charging time in the previous charging. As a result, in the under-aging charging step, the cells serving as charging targets are charged with a charging capacity or charging time corresponding to the number of charging times. This makes it possible to prevent unnecessary charging and shorten the time required to complete charging.

According to a method for manufacturing a bipolar secondary battery according to the present disclosure recited in claim 3, in the configuration recited in claim 1 or claim 2, in the under-aging charging step, an abnormality determination condition for determining that cells serving as charging targets are abnormal may be set to be a case in which at least one variation amount of a voltage variation amount with respect to a time change and a variation amount of a battery capacity with respect to a voltage change deviates from a predetermined error range of the variation amount.

For example, if there is an extreme condition change during charging, the voltage variation amount or the variation amount of the battery capacity deviates from a normal range. For example, when a short circuit occurs in cells, the voltage does not increase and the amount of change in voltage becomes small. Therefore, in the method for manufacturing a bipolar secondary battery according to the present disclosure recited in claim 3, during the under-aging charging step, an abnormality determination condition for determining that cells serving as charging targets are abnormal is set to be a case in which at least one variation amount of a voltage variation amount with respect to a time change and a variation amount of a battery capacity with respect to a voltage change deviates from a predetermined error range of the variation amount. As a result, an abnormality is determined when the voltage variation amount or the variation amount of the battery capacity deviates from the predetermined error ranged thereof, so that it is possible to detect defective products in the under-aging charging step without passing through an inspection step.

According to a method for manufacturing a bipolar secondary battery according to claim 4, in the configuration recited in any one of claims 1 to 3, in the under-aging charging step, an abnormality determination condition for the cells serving as charging targets in a charging suspended state is set to be a case in which a voltage after a lapse of a preset specified period of time from suspension of charging is equal to or less than a specified value of a voltage preset for each number of charging times.

For example, the cells are closer to full charge as the number of charging times increases, so that the voltage drop under suspension of charging tends to subside. Therefore, in the method for manufacturing a bipolar secondary battery according to the present disclosure recited in claim 4, the abnormality determination condition for the cells serving as charging targets under suspension of charging is set to be a case in which the voltage after a preset specified time has elapsed from suspension of charging is equal to or less than a specified value of a voltage preset for each number of charging times. As a result, abnormality is determined when the voltage under suspension of charging is equal to or less than a specified value of a voltage preset for each number of charging times, so that it is possible to detect defective products in the under-aging charging step without passing through an inspection step.

According to a method for manufacturing a bipolar secondary battery according to claim 5, in the configuration recited in any one of claims 1 to 4, the positive electrode uses lithium iron phosphate as a positive electrode active material.

In the method for manufacturing a bipolar secondary battery according to the present disclosure recited in claim 5, the positive electrode uses lithium iron phosphate as the positive electrode active material, so that the voltage drop in the vicinity of the dissolution potential of foreign substances is steeper. Therefore, it is easier to obtain the effect of the present disclosure.

As described above, the method for manufacturing a bipolar secondary battery according to the present disclosure has an excellent effect in which the high-temperature aging time can be shortened in the high-temperature aging step.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view of an electrode body according to an embodiment of the present disclosure;

FIG. 2 is a sectional view that schematically shows a schematic configuration of a two-dimensional battery according to the embodiment of the present disclosure;

FIG. 3 is a graph showing the dissolution rate corresponding to the potential of SUS foreign substance;

FIG. 4 is a diagram showing the relation between the voltage and the dissolution size of SUS foreign substance over time in odd-numbered cells according to a first embodiment of the present disclosure;

FIG. 5 is a diagram showing the relation between the voltage and the dissolution size of SUS foreign substance over time in odd-numbered cells according to a second embodiment of the present disclosure;

FIG. 6 is a diagram showing the relation between the voltage and the dissolution size of SUS foreign substance over time in odd-numbered cells according to a third embodiment of the present disclosure;

FIG. 7 is a diagram showing a switching determination condition of charging capacity for the number of charging times in odd-numbered cells;

FIG. 8 is a diagram showing a switching determination condition of charging time for the number of charging times in odd-numbered cells;

FIG. 9 is a graph of a charging curve line showing the relation of the voltage to the charging time;

FIG. 10A is a diagram showing a voltage variation amount with respect to time;

FIG. 10B is a diagram showing a voltage variation amount with respect to a voltage;

FIG. 11 is a diagram showing a variation amount of a battery capacity with respect to the voltage;

FIG. 12 is a diagram showing the relation between the charging suspension lapse time and the voltage for each number of charging times;

FIG. 13 is a diagram showing the relation between the number of charging times and the voltage after a lapse of 2 hours from suspension of charging; and

FIG. 14 is a diagram showing the relation between the number of charging times and the voltage after 10 hours from suspension of charging.

### DETAILED DESCRIPTION OF EMBODIMENTS

A method for manufacturing a secondary battery according to an embodiment of the present disclosure will be described below with reference to the accompanying drawings. A secondary battery 100 of the present embodiment is used for, for example, a lithium ion secondary battery or a nickel-metal hydride secondary battery which is an example of a non-aqueous electrolyte secondary battery. The non-aqueous electrolyte secondary batteries are used, for example, as batteries for various vehicles such as a forklift, a hybrid vehicle, and an electric vehicle. The non-aqueous electrolyte secondary battery is, for example, a flat stacking battery, and specifically, it is configured by stacking a plurality of bipolar electrodes 10 described below.

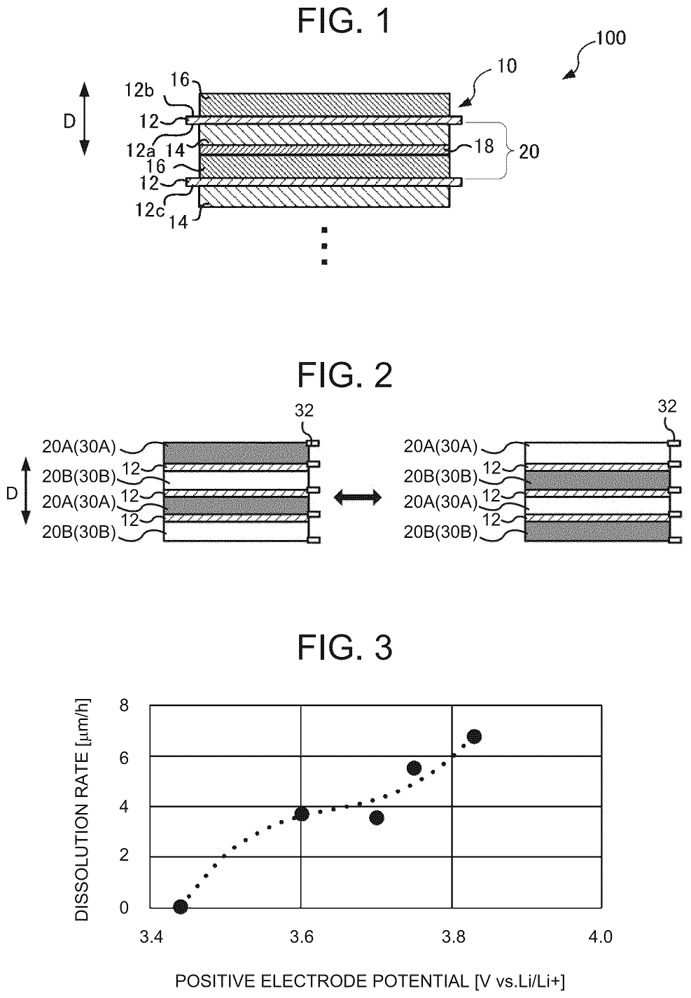

As shown in FIG. 1, the bipolar electrode 10 includes a current collector 12 having one surface 12a and another surface 12b provided on the opposite side of the one surface 12a, a positive electrode composite material layer 14 as a positive electrode provided on the one surface 12a, and a negative electrode composite material layer 16 as a negative electrode provided on the other surface 12b. The bipolar electrode 10 can be easily obtained by coating one composite material of a negative electrode composite material or a positive electrode composite material onto the current collector 12 and drying it, and then coating the other composite material and drying in the same manner. The bipolar electrode 10 may be pressed and cut as necessary.

The current collector 12 is formed of a rectangular metal plate made of metal such as aluminum, stainless steel, nickel, or copper. Alternatively, it may be a foil whose metal surface is coated with aluminum, copper, or the like. Furthermore, an edge 12c of the current collector 12 is formed into a rectangular frame shape, and serves as an uncoated area where the positive electrode composite material layer 14 and the negative electrode composite material layer 16 are not coated. Note that the metal member forming the current collector 12 may be appropriately selected from one or more metal members according to the purpose.

The positive electrode composite material layer 14 includes a positive electrode active material, a conducting agent, and a binder. Examples of the positive electrode active material include lithium composite oxide. Examples of the lithium composite oxide include lithium cobalt oxide, lithium nickel oxide, lithium manganate, lithium iron phosphate (LFP), LiNi_{1/3}Co_{1/3}Mn_{1/3}O₂, and the like. The lithium complex oxide may contain at least one selected from the group consisting of F, Cl, N, S, Br, and I. The shape of the positive electrode active material is not particularly limited. For example, it may be spherical (for example, true spherical, ellipsoidal, or the like), fibrous, or the like.

Examples of the conducting agent include carbon materials such as acetylene black, Ketjenblack, vapor grown carbon fiber (VGCF (registered trademark)), and carbon nanotubes (CNT). The content of the conducting agent is, for example, 3% by mass to 5% by mass with respect to the negative electrode active material.

Examples of the binder include polyvinylidene fluoride (PVDF)/NMP-based binders, styrene-butadiene rubber (SBR)/water-based binders, and polytetrafluoroethylene (PTFE)/water-based binders. The content of the binder is, for example, 3% by mass to 5% by mass with respect to the negative electrode active material.

The negative electrode composite material layer 16 includes a negative electrode active material, a conducting agent, and a binder. Examples of the negative electrode active material include Li-based active materials such as metallic lithium, carbon-based active materials such as graphite, oxide-based active material such as lithium titanate (for example, Li₄Ti₅O₁₂), and Si-based active material such as simple Si, and the like. The shape of the negative electrode active material is not particularly limited. For example, it may be spherical (for example, true spherical, ellipsoidal, or the like), fibrous, or the like.

Like the positive electrode composite material layer 14, examples of the conducting agent include carbon materials such as acetylene black, Ketjenblack, vapor grown carbon fiber (VGCF (registered trademark)), and carbon nanotubes (CNT). The content of the conducting agent is, for example, 3% by mass to 5% by mass with respect to the negative electrode active material.

Like the positive electrode composite material layer 14, examples of the binder include polyvinylidene fluoride (PVDF)/NMP-based binders, styrene-butadiene rubber (SBR)/water-based binders, polytetrafluoroethylene (PTFE)/water-based binders, and the like. The content of the binder is, for example, 3% by mass to 5% by mass with respect to the negative electrode active material.

The bipolar electrodes 10 configured as described above are alternatively stacked with electrolyte layers 18 being interposed therebetween as shown in FIG. 2, thereby constituting a bipolar secondary battery 100.

In the present embodiment, the electrolyte layer 18 may include a solid electrolyte layer or a separator and an electrolytic solution.

When the electrolyte layer 18 is a solid electrolyte layer, examples of the solid electrolyte include oxide solid electrolytes such as lithium lanthanum zirconate, LiPON, Li_{1+X}Al_{X}Ge_{2-X}(PO₄)₃, Li—SiO-based glass, and Li—Al—S—O-based glass; sulfide solid electrolytes such as Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—P₂O₅, LiI—Li₃PO₄—P₂S₅, and Li₂S—P₂S₅—GeS₂. The solid electrolyte layer can be obtained by pressing the solid electrolyte.

When the electrolyte layer 18 includes a separator and an electrolytic solution, examples of the separator include resin sheets such as polyethylene (PE) and polypropylene (PP). Furthermore, the electrolytic solution includes a predetermined electrolyte and a solvent, and examples of the predetermined electrolyte include LiPF₆, LiBF₄, LiAsF₆, Li(CF₃SO₂)₂N, Li(C₂F₅SO₂)₂N, LiTaF₆, LiClO₄, LiCF₃SO₃, and the like.

Examples of the solvent include cyclic-carbonate-based solvents such as ethylene carbonate (EC) and propylene carbonate (PC); chain-carbonate-based solvents such as dimethyl carbonate (DMC), diethyl carbonate (DEC), and ethylmethyl carbonate (EMC). The concentration of the electrolytic solution is, for example, 0.1 to 1 mol/L.

In the method for manufacturing the secondary battery 100 of the present embodiment, after the manufacturing of the secondary battery 100 is completed, the secondary battery 100 is subjected to an initial charging step and a high-temperature aging step. The initial charging step is performed at a relatively low charging rate, so that the temperature of the secondary battery 100 is restrained from increasing. In the present embodiment, CCCV charging is adopted as an example. The CCCV charging is a method in which charging is first performed with a constant current (CC), the control is switched to control based on a constant voltage (CV) and charging is continued when the battery voltage reaches a specified value, and the charging is performed until full charge has been achieved while an overvoltage charged state is avoided. In the charging step, full charge is performed with state of charge (SOC) of 100%, but full charge may be performed with SOC of 90% or the like. In the present embodiment, the charging step is performed, for example, at room temperature of about 20° C.

Here, the secondary battery 100 of the present embodiment is a bipolar secondary battery in which a plurality of bipolar electrodes 10 is stacked with the electrolyte layers 18 being interposed therebetween. As shown in FIG. 1, in the present embodiment, the positive electrode composite material layer 14, the electrolyte layer 18, and the negative electrode composite material layer 16 which are provided between the adjacent current collectors 12 in a stacking direction D constitute one cell 20. In the bipolar secondary battery 100, when each cell 20 is charged, a terminal 32 connected to the current collector 12 located between the adjacent cells 20 is used, so that it is impossible to charge the adjacent cells 20 at the same time.

Therefore, in the present embodiment, two sets of cells alternately arranged in the stacking direction D are charged by turns one after the other. As shown in FIG. 2, one set of cells arranged at every other tier from the upper side to the lower side in the stacking direction D are defined as odd-numbered cells 20A and the other set of cells arranged next to the respective odd-numbered cells 20A in the stacking direction D are defined as even-numbered cells 20B. Further, a plurality of odd-numbered cells 20A are grouped together to define an odd-numbered cell group 30A as a first cell group, and a plurality of even-numbered cells 20B are grouped together to define an even-numbered cell group 30B as a second cell group. In the present embodiment, the odd-numbered cell group 30A and the even-numbered cell group 30B are alternately charged. Note that colored cells 20 indicate cells 20 under charging in FIG. 2.

After the charging step is completed, the high-temperature aging step is then performed. The high-temperature aging step is a step in which the secondary battery 100 charged in the charging step is stored under a high-temperature environment. In the high-temperature aging step, the secondary battery 100 is chemically stabilized and activated. In other words, when there is a minute short circuit caused by metal foreign substances which have been contaminated into the cells 20 due to the manufacturing process, materials, or the like, dissolution and precipitation (chemical reaction) of the metal foreign substances are accelerated by increasing the temperature, thereby detecting the short circuit. Therefore, the high-temperature aging step is performed by keeping the temperature higher than normal temperature, for example, at a high temperature of about 60° C. in the present embodiment.

However, for example, when the secondary battery 100 is a lithium ion secondary battery, the voltage (positive electrode potential) immediately drops when initial charging is suspended. As described above, in the present embodiment, since the odd-numbered cell group 30A and the even-numbered cell group 30B are alternately charged, it is difficult to keep all the cells 20 at a specified voltage during charging in series connection. Furthermore, when the metal foreign substances that are assumed to be contaminated are, for example, SUS304, an essential condition of 62.5° C. or more and 3.60 V or more is required to dissolve the SUS304, so that charging is required during the high-temperature aging step.

Therefore, the present embodiment includes an under-aging charging step of alternately charging the odd-numbered cell group 30A and the even-numbered cell groups 30B during the high-temperature aging step. In this under-aging charging step, a completion condition of charging for at least one of the odd-numbered cell group 30A and the even-numbered cell group 30B is determined based on a dissolution rate calculated based on the type of metal foreign substance and the positive electrode potential, and the voltage and aging time of each cell 20 in the under-aging charging step.

For example, when possible foreign substance is an SUS foreign substance, the dissolution rate differs according to the positive electrode potential as shown in FIG. 3. Specifically, as the positive electrode potential is higher, the dissolution rate is higher. As an example, it can be assumed that the SUS foreign substance is desired to be dissolved until the outer diameter size (hereinafter referred to as dissolution size) is reduced to 200 μm or less. In this case, the voltage and time conditions required to reduce the dissolution size of the SUS foreign substance to 200 μm or less in each cell 20 are preset based on the dissolution rate corresponding to the positive electrode potential of the SUS foreign substance (see FIG. 3), and the completion of charging is determined when the set conditions are satisfied. Specifically, as an example, time t is calculated so as to satisfy the following formula (1). Here, t represents the time (h) and x represents the dissolution rate (μm/h).

TABLE 1

| ELECTRODE | BATTERY | DISSOLUTION | |
|---|---|---|---|
| POTENTIAL | VOLTAGE | RATE x | TIME t |
| V vs. Li | V | μm/h | h |
| 3.83 | 3.75 | 6.592 | CALCULATED |
| | | | FROM |
| | | | FORMULA (1) |
| 3.75 | 3.67 | 4.531 | CALCULATED |
| | | | FROM |
| | | | FORMULA (1) |
| 3.7 | 3.62 | 3.919 | CALCULATED |
| | | | FROM |
| | | | FORMULA (1) |
| 3.6 | 3.52 | 3.219 | CALCULATED |
| | | | FROM |
| | | | FORMULA (1) |

200 ≤ x_{3.67-3.75} × t_{3.67-3.75} + x_{3.62-3.67} × t_{3.62-3.67} + x_{3.53-3.62} × t_{3.53-3.62} . . . (1)

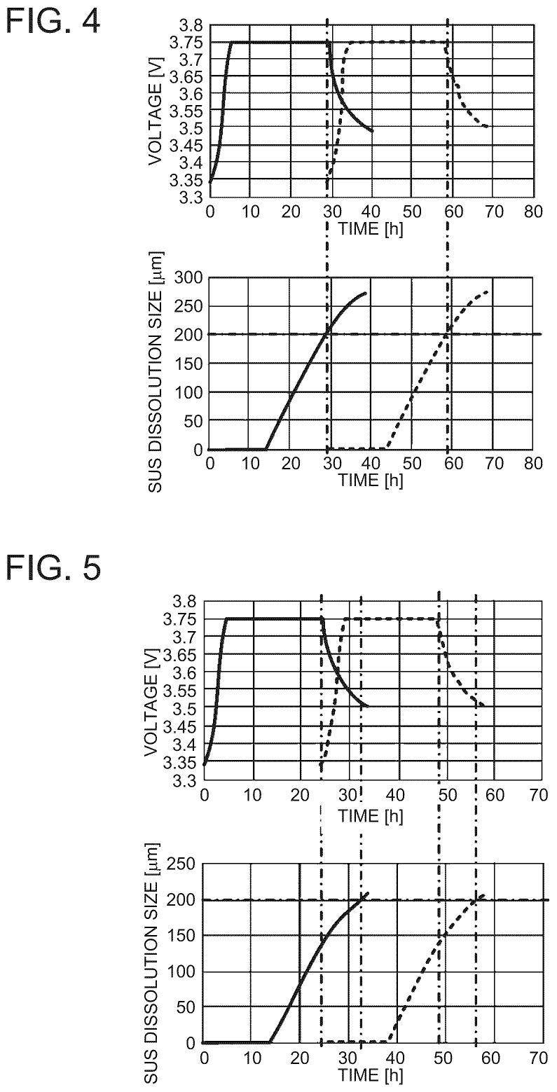

FIG. 4 is a diagram showing the relation between the voltage and the dissolution size of the SUS foreign substance with respect to the lapse time t in the odd-numbered cell 20A according to the first embodiment of the present disclosure. In FIG. 4, a solid line indicates a graph of the odd-numbered cell 20A, and a dotted line indicates a graph of the even-numbered cell 20B. As shown in FIG. 4, in the first embodiment, as an example, charging of the odd-numbered cells 20A is started to keep the voltages of the odd-numbered cells 20A at 3.75 (v), and the charging of the odd-numbered cells 20A is completed after lapse of 28 to 29 hours which corresponds to time t at which the dissolution size of the SUS foreign substance has reached 200 μm. When charging of the odd-numbered cells 20A is completed, charging of the even-numbered cells 20B is then started. Specifically, in the above Table 1, a dissolution rate x when the battery voltage is equal to 3.75 (v) is equal to 6.592 (μm/h), so that the time t is calculated by applying the above value to the above formula (1).

As in the case of the odd-numbered cells 20A, charging of the even-numbered cells 20B is started to keep the voltages of the even-numbered cells 20B at 3.75 (v), and the charging for the even-numbered cells 20B is completed after a lapse of 58 hours which corresponds to the time t at which the dissolution size of the SUS foreign substance has reached 200 μm. In other words, in the odd-numbered cells 20A and the even-numbered cells 20B (the odd-numbered cell group 30A and the even-numbered cell group 30B), the SUS foreign substance is dissolved in 58 hours.

FIG. 5 is a diagram showing the relation between the voltage and the dissolution size of the SUS foreign substance with respect to the lapse of time t in the odd-numbered cells 20A according to a second embodiment of the present disclosure. As shown in FIG. 5, in the second embodiment, as an example, charging of the odd-numbered cells 20A is started to keep the voltages of the odd-numbered cells 20A at 3.75 (V), and charging of the odd-numbered cells 20A is completed after a lapse of 24 hours which corresponds to time t at which the solution size of the SUS foreign substance can reach 200 μm by the course of nature. When charging of the odd-numbered cells 20A is completed, charging of the even-numbered cells 20B is then started.

In other words, in addition to the dissolution of SUS foreign substance during charging (while the voltage is kept at a specified voltage), the SUS foreign substance is also dissolved in each cell 20 during rest after the charging (while the voltage drops from the specified voltage). Therefore, by obtaining the value of the voltage with respect to the lapse of time in advance, the time at which the dissolution size of the SUS foreign substance can reach 200 μm by the course of nature can be acquired based on the above formula (1).

As shown in FIG. 5, in the odd-numbered cells 20A, the dissolution size of the SUS foreign substance has reached 200 μm after a lapse of 33 hours from the start of charging. In other words, dissolution by the course of nature is performed over a period of 9 hours after charging is completed.

In the same way as the odd-numbered cells 20A, charging of the even-numbered cells 20B is started to keep the voltages of the even-numbered cells 20B at 3.75 (V), and charging of the even-numbered cells 20B is completed after a lapse of 48 hours which corresponds to time t at which the dissolution size of the SUS foreign substance can reach 200 μm by the course of nature. After the charging of the even-numbered cells 20B is completed, dissolution by the course of nature is performed over a period of 9 hours. In other words, in the odd-numbered cells 20A and the even-numbered cells 20B (the odd-numbered cell group 30A and the even-numbered cell group 30B), the SUS foreign substance is dissolved in 57 hours, and the time required to dissolve the SUS foreign substance can be shortened by one hour as compared with the first embodiment described above.

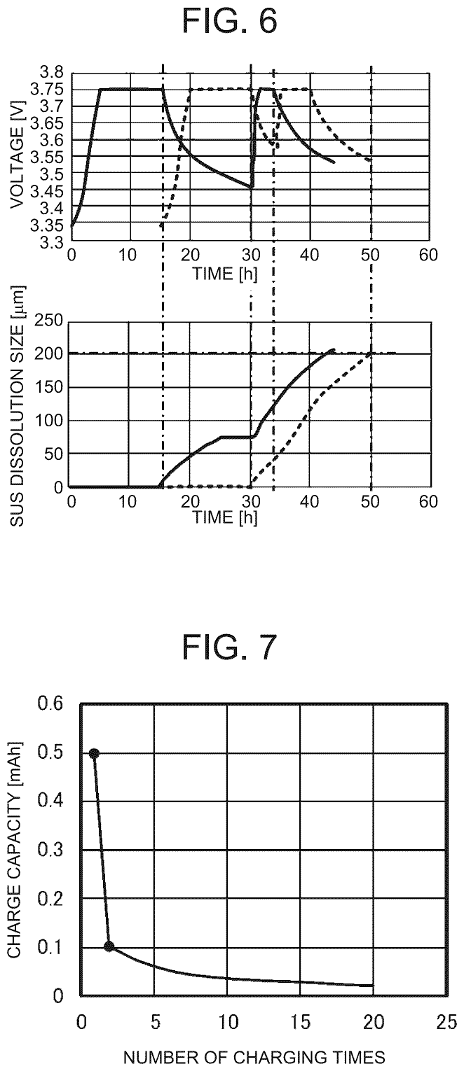

FIG. 6 is a diagram showing the relation between the voltage and the dissolution size of SUS foreign substance with respect to the lapse of time t in the odd-numbered cells 20A according to a third embodiment of the present disclosure. As shown in FIG. 6, in the third embodiment, as an example, after charging of the odd-numbered cells 20A is started to keep the voltages of the odd-numbered cells 20A at 3.75 (V) for 10 hours, the first charging thereof is completed. When the first charging of the odd-numbered cells 20A is completed, the first charging of the even-numbered cells 20B is then started. In the odd-numbered cells 20A, dissolution continues by the course of nature even after the first charging thereof is completed.

Similarly to the odd-numbered cells 20A, after charging of the even-numbered cells 20B is started to keep the voltages of the even-numbered cells 20B at 3.75 (V) for 10 hours, the first charging of the even-numbered cells 20B is completed. When the first charging of the even-numbered cells 20B is completed, the second charging of the odd-numbered cells 20A is started. In the even-numbered cells 20B, dissolution continues by the course of nature even after the first charging thereof is completed.

After the second charging of the odd-numbered cells 20A is started to keep the voltages of the odd-numbered cells 20A at 3.75 (V) for 2.5 hours, the second charging is completed. When the second charging of the odd-numbered cells 20A is completed, the second charging of the even-numbered cells 20B is then started. In the odd-numbered cells 20A, dissolution continues by the course of nature even after the second charging thereof is completed.

Similarly to the odd-numbered cells 20A, after the second charging of the even-numbered cells 20B is started to keep the voltages of the even-numbered cells 20B at 3.75 (V) for 2.5 hours, the second charging of the even-numbered cells 20B is completed. In the even-numbered cells 20B, dissolution also continues by the course of nature even after the second charging is completed.

In the third embodiment, unlike the first and second embodiments described above, charging is performed twice individually on the odd-numbered cells 20A and the even-numbered cells 20B. In other words, the time for dissolution by the course of nature is increased. As a result, the SUS foreign substance is dissolved in the odd-numbered cells 20A and the even-numbered cells 20B (the odd-numbered cell group 30A and the even-numbered cell group 30B) in 50 hours, and the time required for dissolving the SUS foreign substance is shortened by 8 hours as compared with the first embodiment described above, and shortened by 7 hours as compared with the second embodiment described above.

Next, actions and effects of the method for manufacturing the bipolar secondary battery 100 according to the first to third embodiments will be described.

The method for manufacturing the bipolar secondary battery 100 according to the first to third embodiments includes an under-aging charging step of alternately charging an odd-numbered cell group 30A having a plurality of odd-numbered cells 20A arranged at every other tier in the stacking direction and an even-numbered cell group 30B having a plurality of even-numbered cells 20B arranged next to the respective odd-numbered cells 20A included in the odd-numbered cell group 30A until a specified voltage is reached during the high-temperature aging step. In the under-aging charging step, a condition for completing charging of the odd-numbered cell group 30A and the even-numbered cell group 30B is determined based on the dissolution rate x calculated based on the type of metal foreign substance and the positive electrode potential, and the voltage V and the aging time t of each cell 20 during the under-aging charging step.

In this way, since the charging completion condition is determined based on the dissolution rate x calculated based on the type of metal foreign substance and the positive electrode potential, and the voltage V and the aging time t of each cell 20 in the aging charging step, as compared with a case in which charging is completed under a completion condition set based on a lowest-voltage cell 20 without considering the dissolution rate x of foreign substance as in a related art, the time required until charging is completed can be shortened in the high-temperature aging step, so that the high-temperature aging time can be shortened.

Furthermore, by considering the dissolution by the course of nature as in the method for manufacturing the bipolar secondary battery 100 according to the second embodiment, it is possible to more shorten the time required until charging is completed as compared with the first embodiment in which the dissolution by the course of nature is not taken into account, so that the high-temperature aging time can be more shortened.

Furthermore, by performing charging while dividing the charging into a plurality of charging times as in the method for manufacturing the bipolar secondary battery 100 according to the third embodiment, it is possible to further shorten the time required until charging is completed as compared with the first embodiment and the second embodiment in which charging is performed at one time, so that the high-temperature aging time can be further more shortened.

Next, a method for manufacturing a bipolar secondary battery 100 according to a fourth embodiment will be described below. In the present embodiment, in the under-aging charging step described above, charging of the cells 20 to be charged is divided into a plurality of charging times. In this case, a switching charging capacity is set as a switching determination condition for switching charging, and the switching charging capacity is set to a value smaller than a charging capacity in previous charging. FIG. 7 is a diagram showing the switching determination condition of the charging capacity (mAh) for the number of charging times in the odd-numbered cells 20A. Note that the value of the charging capacity is set each time charging is performed, and a value corresponding to the number of charging times is set.

Here, as an example, the cell 20 includes LFP as the positive electrode composite material layer 14, and includes graphite as the negative electrode composite material layer 16. Furthermore, the initial charging conditions in the initial charging step is set to 25° C., 3.75 V—CC charging, and charging rate of 0.06C. Furthermore, the charging condition in the aging charging step is set to 65° C., 3.75 V—CC charging (SOC 100%), and a charging rate of 0.0017C, a charging suspension condition is set to 65° C. and 10 hours, and the number of repetitive charging times is set to 20 times.

As shown in FIG. 7, as an example, if the switching determination condition for the first charging in the odd-numbered cell 20A is set to a time when the charging capacity of the cell reaches 0.5 (mAh), the switching determination condition for the second charging is set to a time when the charging capacity of the cell is equal to 0.1 (mAh) which is smaller than the charging capacity in the first charging. In other words, when charging is performed until the charging capacity has reached 0.1 mAh in the second charging, charging is switched from the odd-numbered cells 20A to the even-numbered cells 20B. Similarly, from the third charging onwards, a value smaller than the charging capacity in the previous charging is used as a switching determination condition. In other words, as shown in FIG. 7, as the number of charging times increases, the value of the charging capacity serving as the switching determination condition is set to be smaller. Here, in FIG. 7, when the value of the charging capacity becomes larger than the value shown by the solid line, charging is switched from the odd-numbered cells 20A to the even-numbered cells 20B, or from the even-numbered cells 20B to the odd-numbered cells 20A. In other words, in FIG. 7, when the value of the charging capacity is smaller than the value indicated by the solid line, charging is performed until the value of the charging capacity becomes larger than the value indicated by the solid line.

Next, the action and effect of the method for manufacturing a bipolar secondary battery 100 in the fourth embodiment will be described.

In the bipolar secondary battery 100, the cells 20 which are not the cells 20 serving as charging targets are brought into a charging suspended state while charging is being performed on the cells 20 as the charging targets, and thus may be discharged under the charging suspended state. Therefore, at the second and subsequent charging times, charges that have been lost during the charging standby state are replenished, so that the charging capacity gradually decreases as compared with the first charging. In other words, as the number of charging times increases, the battery approaches a full charge state, and the charging capacity decreases.

In the method for manufacturing the bipolar secondary battery 100 according to the fourth embodiment, a switching charging capacity is set as a switching determination condition for switching the charging of the cells 20 serving as charging targets, and the switching charging capacity is set to a value smaller than a charging capacity in previous charging. Therefore, in the aging charging step, the cells 20 as the charging targets are charged with the charging capacity corresponding to the number of charging times. As a result, it is possible to prevent unnecessary charging and shorten the time required to complete charging.

Note that in the fourth embodiment, as shown in FIG. 7, the value of the charging capacity is set according to the number of charging times, but the present disclosure is not limited to this style. The value of ΔSOC (%) may be set instead of the charging capacity. Here, ΔSOC (%) is a set value expressed as charging capacity (Ah)/cell capacity (Ah).

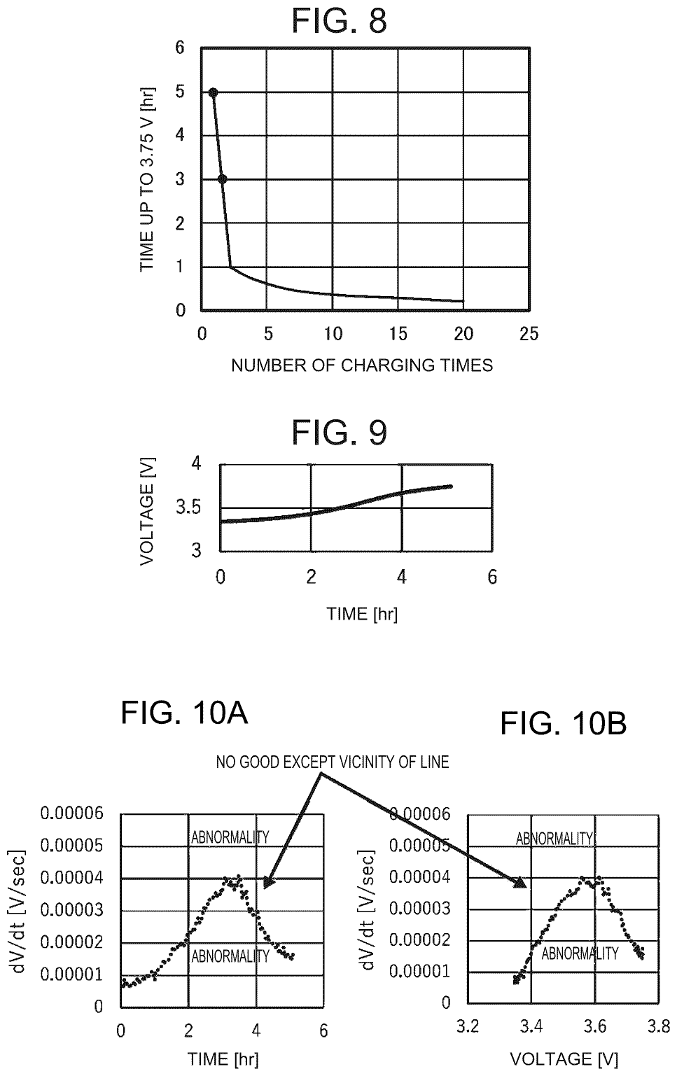

Next, a method for manufacturing a bipolar secondary battery 100 according to a fifth embodiment will be described below. In the fourth embodiment described above, the switching charging capacity is set as the switching determination condition for switching charging, and the switching charging capacity is set to a value smaller than a charging capacity in previous charging. On the other hand, in the present embodiment, a switching charging time is set as a switching determination condition for switching charging, and the switching charging time is set to a time shorter than a charging time in the previous charging. FIG. 8 is a diagram showing the switching determination condition for the charging time (hr) up to 3.75 V with respect to the number of charging times in the odd-numbered cells 20A. Note that the value of the charging time is set each time charging is performed, and the value corresponding to the number of charging times is set. Note that the cells 20 of the present embodiment have the same configuration as the cells 20 of the fourth embodiment.

As shown in FIG. 8, as an example, if the switching determination condition for the first charging is a time when the cell charging time has reached 5 hours up to 3.75 V in the odd-numbered cells 20A, then the switching determination condition for the second charging is set to a time when the cell charging time has reached 3 hours, which is shorter than the charging time in the first charging. In other words, when charging is performed in the second charging until the charging time has reached 3 hours, charging is switched from the odd-numbered cells 20A to the even-numbered cells 20B. Similarly, from the third charging onwards, the charging time shorter than the charging time in the previous charging is also used as the switching determination condition. In other words, as shown in FIG. 8, as the number of charging times increases, the value of the charging time serving as the switching determination condition is set to be smaller. Here, in FIG. 8, when the charging time becomes longer than the value indicated by the solid line, charging is switched from the odd-numbered cells 20A to the even-numbered cells 20B or from the even-numbered cells 20B to the odd-numbered cells 20A. In other words, in FIG. 7, when the charging time is shorter than the value indicated by the solid line, charging is performed until the charging time becomes longer.

Next, the action and effect of the method for manufacturing the bipolar secondary battery 100 in the fifth embodiment will be described.

In the bipolar secondary battery 100, the cells 20 that are not the cells 20 serving as charging targets are brought into a charging suspended state while the cells 20 serving as charging targets are being charged, and may be discharged under the charging suspended state. Therefore, from the second charging onwards, charges that have been lost during charging standby state are replenished, so that the charging capacity gradually decreases and the charging time gradually shortens as compared with the first charging. In other words, as the number of charging times increases, the battery approaches full charge, so that the charging time becomes shorter.

In the method for manufacturing the bipolar secondary battery 100 according to the fifth embodiment, a switching charging time is set as a switching determination condition for switching charging of the cells 20 serving as charging targets, and the switching charging time is set to a time shorter than the charging time in the previous charging. Therefore, in the under-aging charging step, the cells 20 serving as charging targets are charged for a charging time corresponding to the number of charging times. As a result, it is possible to prevent unnecessary charging and shorten the time required for completing charging.

In the fifth embodiment, as shown in FIG. 8, the value of the charging time up to 3.75 V is set according to the number of charging times, but the present disclosure is not limited to this style. Instead of the charging time, the value of the charging time (h) at 1C rate may be set. Here, the charging time (h) at 1C rate is a set value represented by charging time (hr) up to 3.75 V×0.0017.

Next, a method for manufacturing a bipolar secondary battery 100 according to a sixth embodiment will be described below. In the present embodiment, an abnormality determination condition for determining that cells 20 serving as charging targets are abnormal is set in the aging charging step described above. The abnormality determination condition is set to be a case in which a voltage variation amount with respect to time change deviates from a predetermined error range of the voltage variation amount. Here, the “error range” indicates values in the range from a lower limit to an upper limit that can be regarded as an error with respect to the value of the voltage variation amount with respect to time change. FIG. 9 is a graph of a charging curve showing the relation of the voltage with the charging time, FIG. 10A is a diagram showing the voltage variation amount with respect to time, and FIG. 10B is a diagram showing the voltage variation amount with respect to the voltage. Note that the cells 20 of the present embodiment have the same configuration as the cells 20 of the fourth embodiment.

Normally, when the cell 20 is charged, the value of the voltage increases by a substantially constant variation amount over time as shown in FIG. 9. However, for example, if there is an extreme condition change during charging, the voltage variation amount would deviate from a normal range. For example, when a short circuit occurs in cells 20, the voltage variation amount of the cell 20 becomes smaller because the voltage of the cell 20 does not increase.

Therefore, in the present embodiment, in the under-aging charging step, the abnormality determination condition for the cells 20 serving as charging targets is set to be a case in which at least one variation amount of the voltage variation amount with respect to time or the voltage variation amount with respect to the voltage deviates from a predetermined error range of the variation amount.

For example, when the first charging is performed at 0.0017C, as shown in FIG. 10A, charging is performed with the voltage variation amount indicated by a dotted line with respect to time. At this time, in the present embodiment, if the voltage variation amount deviates from the error range of the values indicated by the dotted line, that is, deviates from the vicinity of the solid line, it is determined that there is an abnormality.

For example, when the first charging is performed at 0.0017C, as shown in FIG. 10B, charging is performed with the voltage variation amount indicated by a dotted line with respect to the voltage. At this time, in the present embodiment, if the voltage variation amount deviates from the error range of the values indicated by the dotted line, that is, deviates from the vicinity of the solid line, it is determined that there is an abnormality.

Next, the action and effect of the method for manufacturing the bipolar secondary battery 100 in the sixth embodiment will be described.

In the method for manufacturing the bipolar secondary battery 100 according to the sixth embodiment, in the under-aging charging step, the abnormality determination condition for the cells 20 serving as charging targets is set to be a case in which at least one variation amount of the voltage variation amount with respect to time or the voltage variation amount with respect to the voltage deviates from a predetermined error range of the variation amount. As a result, when the voltage variation amount deviates from the predetermined error range thereof, it is determined that the voltage variation amount is abnormal, so that it is possible to detect defective products in the under-aging charging step without passing through an inspection step.

Note that in the sixth embodiment, as shown in FIGS. 10A and 10B, the value of the voltage variation amount is set with respect to time or the voltage, but the present disclosure is not limited to this style. Instead of the value of the voltage variation amount, the value of the voltage variation amount at 1C rate may be set. Here, the voltage variation amount at 1C rate is a set value expressed by the voltage variation amount (V/sec)/0.0017.

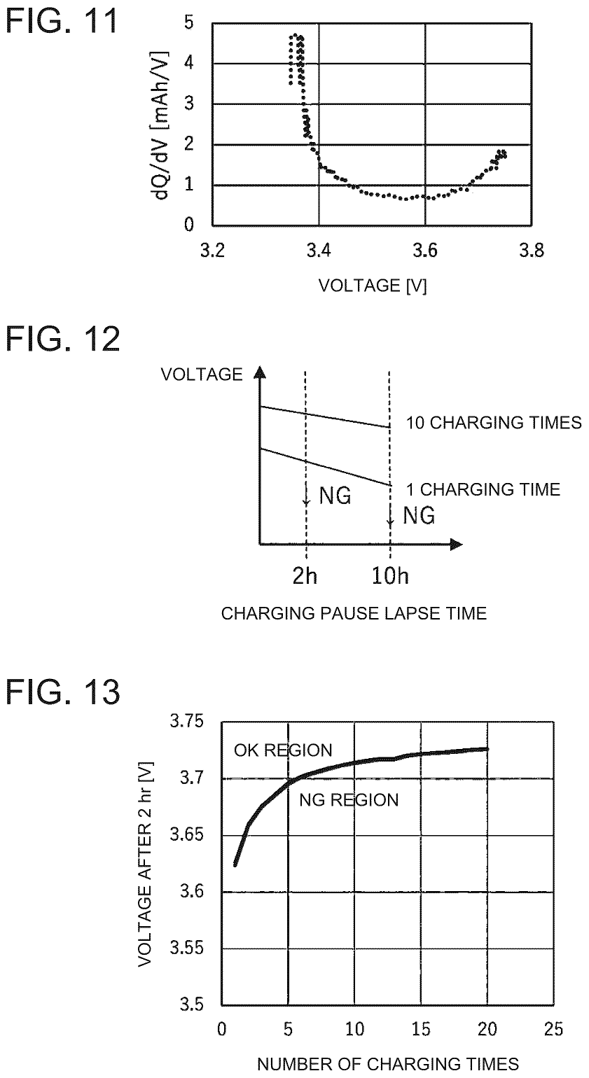

Next, a method for manufacturing a bipolar secondary battery 100 according to a seventh embodiment will be described below. In the sixth embodiment described above, the abnormality determination condition is set to be a case in which the voltage variation amount with respect to time and the voltage variation amount with respect to the voltage deviates from the predetermined error range of the variation amount. In the present embodiment, the abnormality determination condition is set to be a case in which the variation amount of the battery capacity with respect to the voltage deviates from a predetermined error range of the variation amount. FIG. 11 is a diagram showing the variation amount of the battery capacity with respect to the voltage. Note that the cells 20 of the present embodiment have the same configuration as the cells 20 of the fourth embodiment.

Normally, when the cell 20 is charged, as shown in FIG. 9, the voltage value increases by a substantially constant variation amount over time. However, for example, when there is an extreme condition change during charging, the voltage variation amount deviates from a normal range, so that the variation amount of the battery capacity also deviates from a normal range.

Therefore, in the present embodiment, the abnormality determination condition for the cells 20 serving as charging targets in the aging charging step is set to be a case in which the variation amount of the battery capacity with respect to the voltage deviates from a predetermined error range of the variation amount.

For example, when the first charging is performed at 0.0017C, as shown in FIG. 11, the charging is performed with the variation amount of the battery capacity indicated by the solid line with respect to the voltage. At this time, in the present embodiment, when the variation amount of the battery capacity deviates from the error range of the values indicated by the solid line, that is, deviates from the vicinity of the solid line, it is determined that the cell is determined as being abnormal.

Next, the action and effect of the method for manufacturing the bipolar secondary battery 100 in the seventh embodiment will be described.

In the method for manufacturing the bipolar secondary battery 100 according to the seventh embodiment, the abnormality determination condition for the cells 20 serving as charging targets in the under-aging charging step is set to be a case in which the variation amount of the battery capacity with respect to the voltage deviates from the predetermined error range of the variation amount. As a result, abnormality is determined if the variation amount of the battery capacity deviates from the predetermined error range, so that it is possible to detect defective products in the under-aging charging step without passing through an inspection step.

Note that in the seventh embodiment, as shown in FIG. 11, the value of the variation amount of the battery capacity is set with respect to the voltage, but the present disclosure is not limited to this style. Instead of the value of the variation amount of the battery capacity, the value of the variation amount of the battery capacity of battery capacity 1 Ah may be set. Here, the variation amount of the battery capacity of the battery capacity 1 Ah is a set value expressed by the variation amount of the battery capacity of battery capacity 1 mAh (mAh/V)/56. Moreover, the value of the variation amount of SOC may be set instead of the value of the variation amount of the battery capacity of battery capacity 1 Ah. Here, the variation amount (%) of SOC is a set value obtained by converting the battery capacity (Ah) of battery capacity 1 Ah to SOC (%).

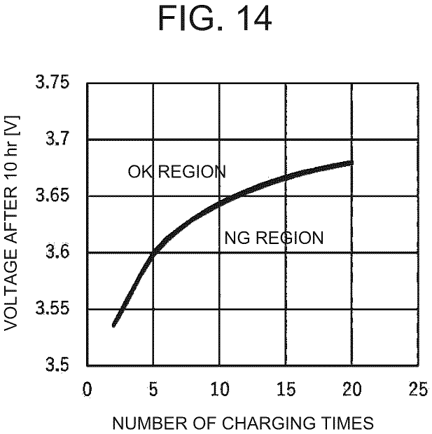

Next, a method for manufacturing a bipolar secondary battery 100 according to an eighth embodiment will be described below. FIG. 12 is a diagram showing the relation between the charging suspension lapse time and the voltage for each number of charging times, FIG. 13 is a diagram showing the relation between the number of charging times and the voltage after a lapse of 2 hours from suspension of charging, and FIG. 14 is a diagram showing the relation between the number of charging times and the voltage after a lapse of 10 hours from suspension of charging. Note that the cells 20 of the present embodiment have the same configuration as the cells 20 of the fourth embodiment.

As shown in FIG. 12, as an example, when the charging of the odd-numbered cells 20A is suspended while the even-numbered cells 20B are being charged, the voltages of the odd-numbered cells 20A decreases as the charging suspension time of the odd-numbered cells 20A elapses. At this time, since the odd-numbered cells 20A that have been charged 10 times are closer to full charge than the odd-numbered cells 20A that have been charged only once, the drop in voltage has subsided.

Therefore, in the present embodiment, in the under-aging charging step, an abnormality determination condition for the cells 20 serving as charging targets under a charging suspended state is set to be a case in which the voltage after a lapse of a preset period of time from suspension of charging is equal to or less than a specified value of a voltage preset for each number of charging times.

In other words, for example, the voltage after a lapse of 2 hours is specified as indicated by a solid line in FIG. 13 for each number of charging times. Similarly, for example, the voltage after a lapse of 10 hours is specified as indicated by a solid line in FIG. 14 for each number of charging times. Note that the specified value is set in consideration of variations. For each number of charging times, at least one of the voltage after 2 hours and the voltage after 10 hours is measured, and when the voltage is lower than the specified value of the voltage set for each number of charging times, it is determined that there is an abnormality because the voltage has dropped too much.

Next, the action and effect of the method for manufacturing the bipolar secondary battery 100 in the eighth embodiment will be described.

In the method for manufacturing the bipolar secondary battery 100 according to the eighth embodiment, the abnormality determination condition for the cells 20 serving as charging targets in the charging suspended state is set to be a case where the voltage after a lapse of a preset specified period of time from suspension of charging is equal to or less than a specified value of a voltage preset for each number of charging times. As a result, an abnormality is determined if the voltage under suspension of charging is equal to or less than a specified value of a voltage preset for each number of charging times, so that it is possible to detect defective products in the under-aging charging step without passing through an inspection step.

### Remarks

Note that in the embodiment described above, the charging completion condition is determined for both the odd-numbered cells 20A (that is, the odd-numbered cell group 30A) and the even-numbered cells 20B (that is, the even-numbered cell group 30B), but the present disclosure is not limited to this style. The effect of the present disclosure can be achieved by determining only the completion condition for either the odd-numbered cells 20A (that is, the odd-numbered cell group 30A) or the even-numbered cells 20B (that is, the even-numbered cell group 30B).

Furthermore, in the present disclosure, the positive electrode active material used for the positive electrode composite material layer 14 as a positive electrode is not limited, but it is preferable to use lithium iron phosphate ions. Lithium iron phosphate has a steeper voltage drop in the vicinity of the dissolution potential of foreign substances, so that the effect of the present disclosure can be more easily obtained.

Furthermore, in the above-described embodiments, SUS such as SUS304 is described as an example of possible foreign substances, but the present disclosure is not limited to this substance. For example, copper contained in the current collector 12, etc. are also assumed as the foreign substances.

Furthermore, the configuration of the present disclosure is not limited to the above embodiments, and the configuration can be changed as appropriate as long as the problem can be solved.

What is claimed is:

1. A method for manufacturing a bipolar secondary battery in which a plurality of cells each including a positive electrode, a negative electrode, and an electrolyte layer are stacked, the method comprising:
an initial charging step of charging, to a specified voltage, a first cell group including a plurality of cells arranged at every other tier in a stacking direction, and a second cell group including a plurality of cells arranged next to the respective cells included in the first cell group;
a high-temperature aging step of performing aging at a high temperature higher than room temperature; and
an under-aging charging step of alternately charging the first cell group and the second cell group in the high-temperature aging step until the first cell group and the second cell group reach the specified voltage, wherein
in the under-aging charging step, a charging completion condition for at least one of the first cell group and the second cell group is determined based on a dissolution rate calculated based on a type of a metal foreign substance and a positive electrode potential, and a voltage and an aging time of each of the cells in the under-aging charging step.

2. The method for manufacturing a bipolar secondary battery according to claim 1, wherein
in the under-aging charging step, a switching charging capacity or a switching charging time is set as a switching determination condition for switching charging of the cells serving as charging targets,
the switching charging capacity has a value smaller than a charging capacity in previous charging, and
the switching charging time is a time shorter than a charging time in the previous charging.

3. The method for manufacturing a bipolar secondary battery according to claim 1, wherein in the under-aging charging step, an abnormality determination condition for determining that the cells serving as charging targets are abnormal is set to be a case in which at least one variation amount of a voltage variation amount with respect to a time change and a variation amount of a battery capacity with respect to a voltage change deviates from a predetermined error range of the variation amount.

4. The method for manufacturing a bipolar secondary battery according to claim 1, wherein in the under-aging charging step, an abnormality determination condition for the cells serving as charging targets in a charging suspended state is set to be a case in which a voltage after a lapse of a preset specified period of time from suspension of charging is equal to or less than a specified value of a voltage preset for each number of charging times.

5. The method for manufacturing a bipolar secondary battery according to claim 1, wherein the positive electrode uses lithium iron phosphate as a positive electrode active material.
